(19) United States
(12) Patent Application Publication
(10) Pub. No.: US 2025/0110396 A1
(43) Pub. Date: Apr. 3, 2025

(54) LIGHT SOURCE APPARATUS AND PROJECTOR

(71) Applicant: SEIKO EPSON CORPORATION, Tokyo (JP)

(72) Inventors: Yuta TOKUNO, AZUMINO-SHI (JP); Makoto ZAKOJI, MATSUMOTO-SHI (JP); Yuichiro IWAMA, AZUMINO-SHI (JP)

(21) Appl. No.: 18/905,300

(22) Filed: Oct. 3, 2024

(30) Foreign Application Priority Data
Oct. 3, 2023 (JP) 2023-171918

(51) Int. Cl. G03B 21/20; G03B 21/16

(52) U.S. Cl. CPC G03B 21/2066; G03B 21/16; G03B 21/204

(57) ABSTRACT

A light source apparatus according to the present disclosure includes: a light emitter that emits light; a light guide member having a first surface on which the light emitted from the light emitter is incident, a second surface facing a side opposite from the first surface, a third surface and a fourth surface that intersect with the first surface and the second surface and face opposite sides, and a light exiting portion via which the light exits; a support section having a support surface that constitutes the bottom surface of a holding groove that holds the light guide member and supports the second surface of the light guide member; a first sidewall section facing the third surface of the light guide member and including a first wall surface constituting one inner side surface of the holding groove; and a second sidewall section facing the fourth surface of the light guide member and including a second wall surface constituting the other inner side surface of the holding groove, and at least one of the first sidewall portion and the second sidewall portion is configured with a member different from the support section.

The present application is based on, and claims priority from JP Application Serial Number 2023-171918, filed Oct. 3, 2023, the disclosure of which is hereby incorporated by reference herein in its entirety.

### BACKGROUND

### 1. Technical Field

The present disclosure relates to a light source apparatus and a projector.

### 2. Related Art

As a light source apparatus used in a projector, there has been a proposed light source apparatus using fluorescence emitted from a phosphor when the phosphor is irradiated with excitation light emitted from a light emitter.

WO 2020/254439 described below discloses a light source apparatus including an excitation light source including a light emitter and a substrate, a base member that fixes the substrate of the excitation light source, a phosphor rod that converts excitation light emitted from the light emitter into fluorescence, and a holder that holds the phosphor rod. In the light source apparatus described above, the phosphor rod is held in a groove formed in the holder.

WO 2020/254439 is an example of the related art.

In the light source apparatus described above, since the holder and the base member are formed as an integral component, increased accuracy with which the groove is processed causes the component as a whole to be determined as a defective component even when there is no problem with the accuracy of the base member itself, resulting in a problem of a decrease in yield of the component.

Furthermore, when a material that excels in thermal conductivity but is expensive is used to form the holder, it is necessary to use the same expensive material to form the base member. That is, when the holder and the base member are integrated with each other into a single structure, which does not allow selection of an optimum material and processing accuracy on a member basis, resulting in a problem of an increase in cost.

### SUMMARY

To solve the problems described above, a light source apparatus according to an aspect of the present disclosure includes a light emitter configured to emit light; a substrate configured to support the light emitter; a light guide member having a first surface on which the light emitted from the light emitter is incident and a second surface facing a side opposite from the first surface; a housing member in which the second surface of the light guide member is placed and which is configured to house at least a portion of the light guide member; and a base member configured as a member different from the housing member and to which the substrate is fixed, and the housing member is supported by the base member.

A projector according to another aspect of the present disclosure includes: the light source apparatus according to the aspect of the present disclosure; a light modulator configured to modulate light output from the light source apparatus; projection optical apparatus configured to project the light modulated by the light modulator.

### BRIEF DESCRIPTION OF THE DRAWINGS

FIG. 1 shows a schematic configuration of a projector according to a first embodiment.

FIG. 2 is a schematic configuration diagram of a first illuminator.

FIG. 3 is an exploded perspective view of a light source apparatus.

FIG. 4 is a plan view of the light source apparatus viewed in a Y-axis direction.

FIG. 5 is a cross-sectional view of the light source apparatus taken along line V-V in FIG. 4.

FIG. 6 is an exploded perspective view showing the configuration of key portions of a light source apparatus according to a second embodiment.

### DESCRIPTION OF EMBODIMENTS

Embodiments of the present disclosure will be described below.

A projector according to an embodiment of the present disclosure is an example of a projector using liquid crystal panels as light modulators.

In the following drawings, elements are drawn at different dimensional scales in some cases for clarity of the elements.

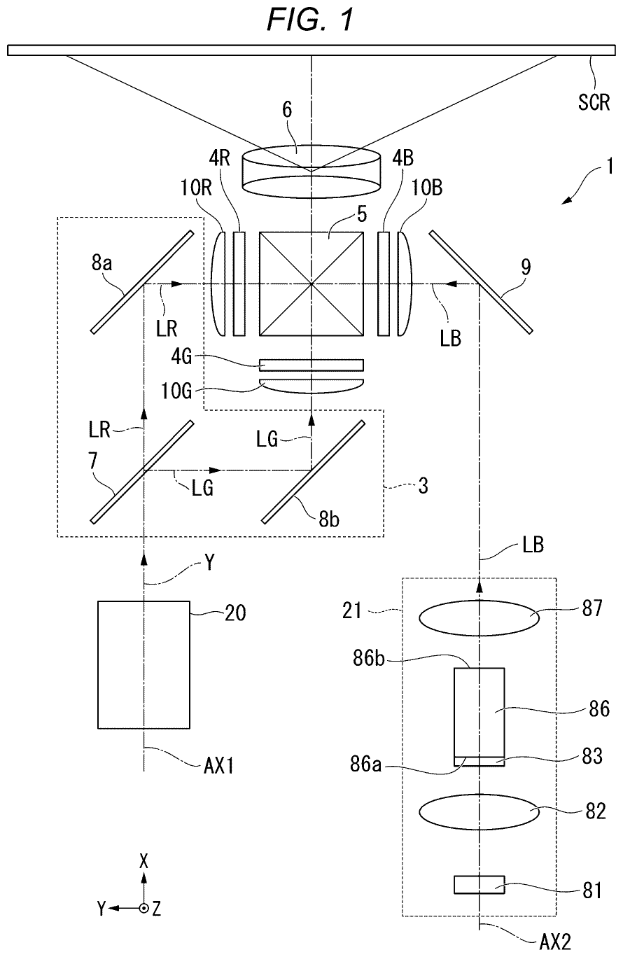

FIG. 1 shows a schematic configuration of a projector 1 according to the present embodiment.

The projector 1 according to the present embodiment is a projection-type image display apparatus that displays a color image on a screen SCR, which is a projection receiving surface, as shown in FIG. 1. The projector 1 includes three light modulators corresponding to three types of color light, red light LR, green light LG, and blue light LB.

The projector 1 includes a first illuminator 20, a second illuminator 21, a color separation system 3, a light modulator 4R, a light modulator 4G, a light modulator 4B, a light combiner 5, and a projection optical apparatus 6.

The first illuminator 20 outputs yellow fluorescence Y toward the color separation system 3. The second illuminator 21 emits the blue light LB toward the light modulator 4B. Detailed configurations of the first illuminator 20 and the second illuminator 21 will be described later.

The description with reference to the drawings will hereinafter be made by using an XYZ orthogonal coordinate system in as required. The Z-axis is an axis along the upward-downward direction of the projector 1. The X-axis is an axis parallel to an optical axis AX1 of the first illuminator 20 and an optical axis AX2 of the second illuminator 21. The Y-axis is an axis perpendicular to the X-axis and the Z-axis. The optical axis AX1 of the first illuminator 20 is the center axis of the fluorescence Y output from the first illuminator 20. The optical axis AX2 of the second illuminator 21 is the center axis of the blue light LB output from the second illuminator 21. One of the two directions along the X-axis is referred to as a +X direction, the opposite direction of the +X direction is referred to as a −X direction, one of the two directions along the Y-axis is referred to as a +Y direction, the opposite direction of the +Y direction is referred to as a −Y direction, one of the two directions along the Z-axis is referred to as a +Z direction, and the opposite direction of the +Z direction is referred to as a −Z direction. The two directions along the X-axis are referred to as an X-axis direction when not distinguished from each other, the two directions along the Y-axis are referred to as a Y-axis direction when not distinguished from each other, and the two directions along the Z-axis are referred to as a Z-axis direction when not distinguished from each other.

The color separation system 3 separates the yellow fluorescence Y output from the first illuminator 20 into the red light LR and the green light LG. The color separation system 3 includes a dichroic mirror 7, a first reflection mirror 8a, and a second reflection mirror 8b.

The dichroic mirror 7 separates the fluorescence Y into the red light LR and the green light LG. The dichroic mirror 7 transmits the red light LR and reflects the green light LG. The second reflection mirror 8b is disposed in the optical path of the green light LG. The second reflection mirror 8b reflects the green light LG reflected off the dichroic mirror 7 toward the light modulator 4G. The first reflection mirror 8a is disposed in the optical path of the red light LR. The first reflection mirror 8a reflects the red light LR having passed through the dichroic mirror 7 toward the light modulator 4R.

In contrast, the blue light LB output from the second illuminator 21 is reflected off a reflection mirror 9 toward the light modulator 4B.

The configuration of the second illuminator 21 will be described below.

The second illuminator 21 includes a second light source section 81, a light collecting lens 82, a diffuser plate 83, a rod lens 86, and a relay lens 87. The second light source section 81 is configured with at least one semiconductor laser. The second light source section 81 outputs the blue light LB, which is laser light. The second light source section 81 is not necessarily configured with a semiconductor laser, and may be configured with an LED that emits blue light.

The light collection lens 82 is configured with a convex lens. The light collection lens 82 causes the blue light LB output from the second light source section 81 to be incident on the diffuser plate 83 with the blue light LB substantially collected at the diffuser plate 83. The diffuser plate 83 diffuses the blue light LB output from the light collection lens 82 into blue light LB diffused by a predetermined degree to generate blue light LB having a substantially uniform light orientation distribution similar to that of the fluorescence Y output from the first illuminator 20. The diffuser plate 83 is, for example, a ground glass plate made of optical glass.

The blue light LB diffused by the diffuser plate 83 enters the rod lens 86. The rod lens 86 has a prismatic shape extending along the direction of the optical axis AX2 of the second illuminator 21. The rod lens 86 has a light incident end surface 86a provided at one end and a light exiting end surface 86b provided at the other end. The diffuser plate 83 is fixed to the light incident end surface 86a of the rod lens 86 via an optical adhesive (not shown). It is desirable that the refractive index of the diffuser plate 83 matches as much as possible with the refractive index of the rod lens 86.

The blue light propagates through the interior of the rod lens 86 while being totally reflected therein and exits via the light exiting end surface 86b with the illuminance distribution of the blue light LB having enhanced uniformity. The blue light LB output from the rod lens 86 enters the relay lens 87. The relay lens 87 causes the blue light LB having the illuminance distribution enhanced in terms of uniformity by the rod lens 86 to be incident on the reflection mirror 9.

The light exiting end surface 86b of the rod lens 86 has a rectangular shape substantially similar to the shape of an image formation region of the light modulator 4B. The blue light LB output from the rod lens 86 is thus efficiently incident on the image formation region of the light modulator 4B.

The light modulator 4R modulates the red light LR in accordance with image information to form image light corresponding to the red light LR. The light modulator 4G modulates the green light LG in accordance with image information to form image light corresponding to the green light LG. The light modulator 4B modulates the blue light LB in accordance with image information to form image light corresponding to the blue light LB.

The light modulators 4R, 4G, and 4B are each, for example, a transmissive liquid crystal panel. Polarizers (not shown) are disposed at the light incident side and the light exiting side of each of the liquid crystal panels. The polarizers each only transmit linearly polarized light polarized in a specific direction.

A field lens 10R is disposed at the light incident side of the light modulator 4R. A field lens 10G is disposed at the light incident side of the light modulator 4G. A field lens 10B is disposed at the light incident side of the light modulator 4B. The field lens 10R parallelizes the chief ray of the red light LR to be incident on the light modulator 4R. The field lens 10G parallelizes the chief ray of the green light LG to be incident on the light modulator 4G. The field lens 10B parallelizes the chief ray of the blue light LB to be incident on the light modulator 4B.

When the image light output from the light modulator 4R, the image light output from the light modulator 4G, and the image light output from the light modulator 4B enter the light combiner 5, the light combiner 5 combines the image light corresponding to the red light LR, the image light corresponding to the green light LG, and the image light corresponding to the blue light LB with one another and outputs the combined image light toward the projection optical apparatus 6. The light combiner 5 is, for example, a cross dichroic prism.

The projection optical apparatus 6 is configured with multiple projection lenses. The projection optical apparatus 6 enlarges the combined image light produced by the light combiner 5 and projects the enlarged image light toward the screen SCR. A color image is thus displayed on the screen SCR.

The configuration of the first illuminator 20 will subsequently be described.

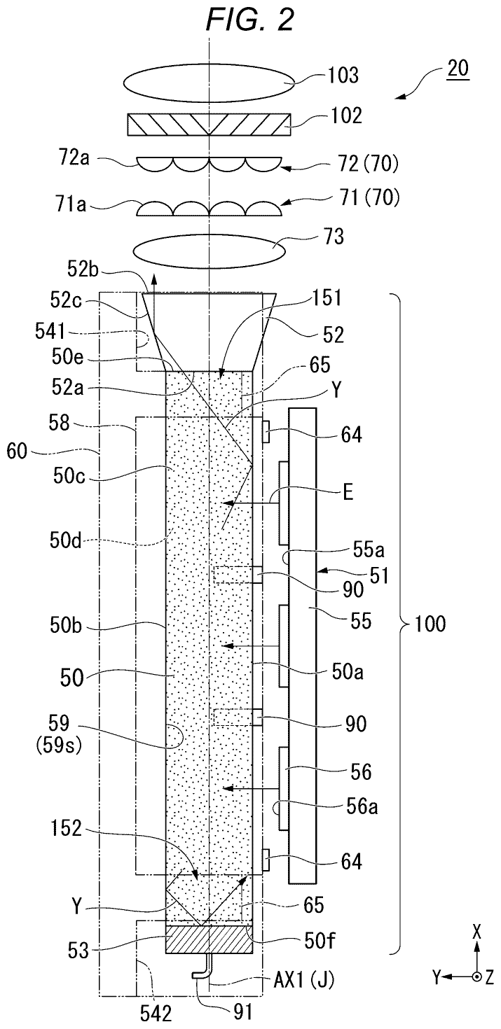

FIG. 2 is a schematic configuration diagram of the first illuminator 20.

The first illuminator 20 includes a light source apparatus 100, an optical integration system 70, a polarization converter 102, and a superimposing system 103, as shown in FIG. 2.

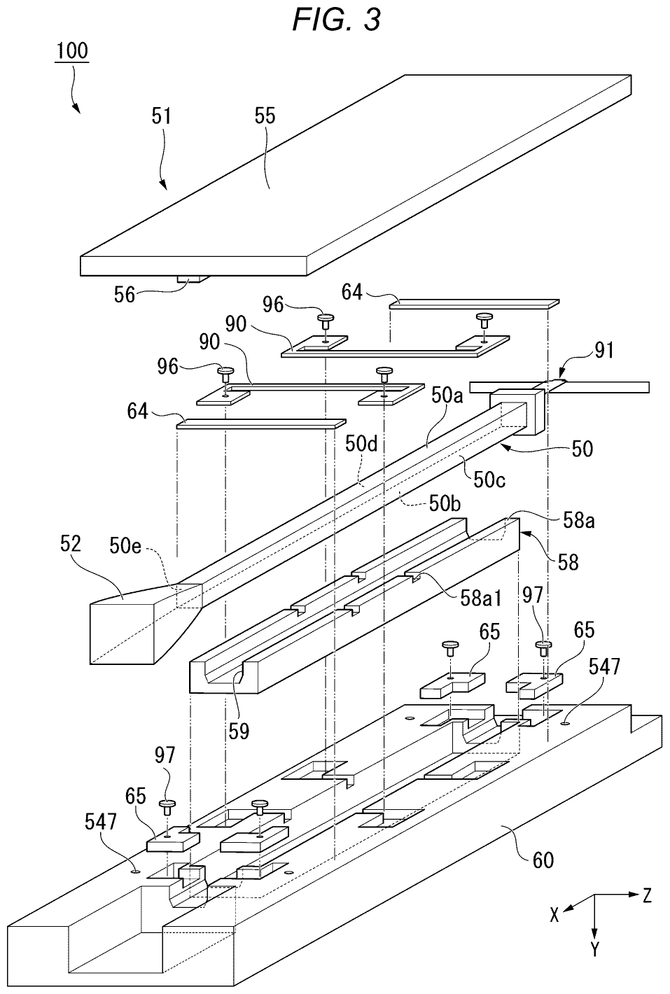

FIG. 3 is a perspective view showing a schematic configuration of the light source apparatus 100.

The light source apparatus 100 includes a wavelength conversion member 50, a first light source section 51, an angle conversion member 52, a mirror 53, a base member 60, a holding member 58, a pair of fixing members 64, position restrictors 65, first pressing members 90, and a second pressing member 91, as shown in FIGS. 2 and 3. The wavelength conversion member 50 in the present embodiment corresponds to a “light guide member” in the claims.

The wavelength conversion member 50 has a quadrangular prismatic shape extending along the X-axis and has six surfaces. In the wavelength conversion member 50, the sides extending along the X-axis are longer than the sides extending along the Y-axis and the sides extending along the Z-axis. The X-axis therefore corresponds to the longitudinal direction of the wavelength conversion member 50. The length of the sides extending along the Y-axis is equal to the length of the sides extending along the Z-axis. That is, the wavelength conversion member 50 taken along the YZ plane perpendicular to the X-axis has a square cross-sectional shape. Note that the wavelength conversion member 50 taken along the YZ plane may have a rectangular cross-sectional shape.

The wavelength conversion member 50 has a first surface 50a, a second surface 50b, a third surface 50c, a fourth surface 50d, a fifth surface 50e, and a sixth surface 50f.

The fifth surface 50e and the sixth surface 50f intersect with the X-axis along the longitudinal direction of the wavelength conversion member 50, and are located at the sides opposite from each other in the X-axis. In the present embodiment, the fifth surface 50e faces the +X side, which corresponds to one of the X-axis directions along the X-axis, and the sixth surface 50f faces the −X side, which corresponds to the other of the X-axis directions.

The first surface 50a and the second surface 50b are surfaces that intersect with the fifth surface 50e and the sixth surface 50f, and face opposite sides along the Y-axis, which intersects with, in the present embodiment, is perpendicular to the X-axis along the longitudinal direction of the wavelength conversion member 50. In the present embodiment, the first surface 50a is located so as to face the −Y side, which corresponds to one of the Y-axis directions along the Y-axis, and the second surface 50b is located so as to face the +Y side, which corresponds to the other of the Y-axis directions.

In the present embodiment, the first surface 50a of the wavelength conversion member 50 is a surface on which light emitted from light emitters 56 of the first light source section 51, which will be described later, is incident.

The third surface 50c and the fourth surface 50d are surfaces that intersect with the first surface 50a and the second surface 50b, and face opposite sides in the Z-axis, which intersects with, in the present embodiment, is perpendicular to the X-axis and the Y-axis. In the present embodiment, the third surface 50c faces the +Z side, which corresponds to one of the Z-axis directions, and the fourth surface 50d faces the −Z side, which corresponds to the other of the Z-axis directions.

In the following description, when the first surface 50a, the second surface 50b, the third surface 50c, and the fourth surface 50d are not distinguished from each other, these surfaces are simply referred to as side surfaces 50a, 50b, 50c, and 50d in some cases.

The wavelength conversion member 50 at least includes a phosphor, and converts excitation light E, which is emitted from the light emitters 56 of the first light source section 51 and has a first wavelength band, into the fluorescence Y, which has a second wavelength band different from the first wavelength band. The excitation light E enters the wavelength conversion member 50 via the first surface 50a. The fluorescence Y is guided through the interior of the wavelength conversion member 50 and then output via the fifth surface 50e. The excitation light E in the present embodiment corresponds to the “first light” in the claims. The fluorescence Y in the present embodiment corresponds to the “second light” in the claims. The fifth surface 50e in the present embodiment corresponds to the “light exiting portion” in the claims.

The wavelength conversion member 50 contains a ceramic phosphor configured with a polycrystalline phosphor that converts the excitation light E in terms of wavelength into the fluorescence Y. The second wavelength band to which the fluorescence Y belongs is a yellow wavelength band ranging, for example, from 490 to 750 nm. That is, the fluorescence Y is yellow fluorescence containing a red light component and a green light component.

The wavelength conversion member 50 may include a single crystal phosphor in place of a polycrystalline phosphor. The wavelength conversion member 50 may instead be made of fluorescent glass. The wavelength conversion member 50 may still instead be configured with a binder which is made of glass or resin and in which a large number of phosphor particles are dispersed. The wavelength conversion member 50 made of any of the materials described above converts the excitation light E into the fluorescence Y.

Specifically, the material of the wavelength conversion member 50 contains, for example, an yttrium-aluminum-garnet-based (YAG-based) phosphor. Consider YAG: Ce, which contains cerium (Ce) as an activator, by way of example, and the wavelength conversion member 50 is made, for example, of a material produced by mixing raw powder materials containing Y₂O₃, Al₂O₃, CeO₃, and other constituent elements with one another and causing the mixture to go through a solid-phase reaction, Y—Al—O amorphous particles produced by using a coprecipitation method, a sol-gel method, or any other wet method, or YAG particles produced by using a spray-drying method, a flame-based thermal decomposition method, a thermal plasma method, or any other gas-phase method.

The first light source section 51 includes a substrate 55 and multiple light emitters 56. Note that the first light source section 51 may include other optical members such as light guide plates, diffuser plates, and lenses. The substrate 55 of the first light source section 51 is fixed to the base member 60 in a region that is not shown.

The multiple light emitters 56 are fixed to one surface 55a of the substrate 55. The number of light emitters 56 of the first light source section 51 in the present embodiment is not limited to a specific number.

The light emitters 56 each have a light emission surface 56a, via which the excitation light E having the first wavelength band exits. The light emitters 56 are each configured, for example, with a light emitting diode (LED). The light emission surface 56a of each of the light emitters 56 faces the first surface 50a of the wavelength conversion member 50, and the light emitters 56 each emit the excitation light E via the light emission surface 56a toward the first surface 50a. The first wavelength band is, for example, a blue-violet wavelength band ranging from 400 nm to 480 nm and has a peak wavelength of, for example, 445 nm.

The holding member 58 is a block-shaped member, and has a groove 59, which is formed in a surface 58a and holds a portion of the wavelength conversion member 50, as shown in FIG. 3. The holding member 58 is supported by the base member 60. The holding member 58 functions as a heat dissipation member that diffuses heat generated in the wavelength conversion member 50 supported inside the groove 59 and releases the heat out of the holding member 58.

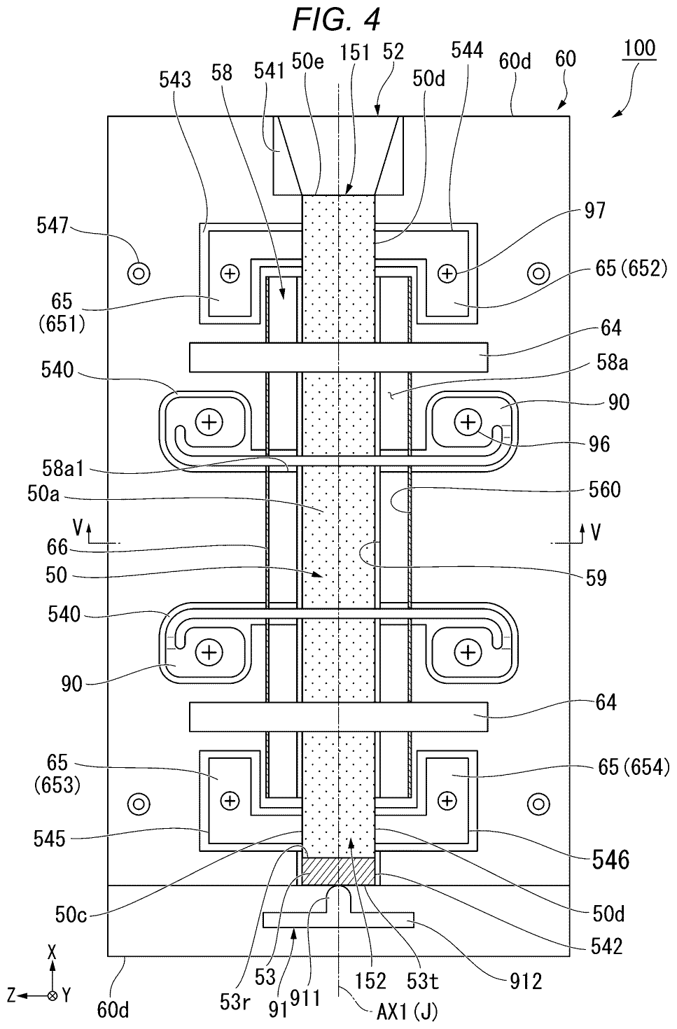

FIG. 4 is a plan view of the light source apparatus 100 viewed in the Y-axis direction. In FIG. 4, the first light source section 51 is not shown for clarity of the figure.

The groove 59 extends in the X-axis direction along the longitudinal direction of the wavelength conversion member 50 and houses a portion of the wavelength conversion member 50.

The wavelength conversion member 50 includes a first protrusion 151, which protrudes from the groove 59 in the +X direction, and a second protrusion 152, which protrudes from the groove 59 in the −X direction.

The first protrusion 151 is a portion including +X-direction-side end portions of the first surface 50a, the second surface 50b, the third surface 50c, and the fourth surface 50d, and the fifth surface 50e. The second protrusion 152 is a portion including −X-direction-side end portions of the first surface 50a, the second surface 50b, the third surface 50c, and the fourth surface 50d, and the sixth surface 50f.

That is, opposite end portions of the wavelength conversion member 50 protrude outward from the groove 59 of the holding member 58.

The persons who have disclosed the present disclosure have considered that when an elongated groove is formed by cutting in an integrated component, it is difficult to ensure the surface accuracy of the groove, and that increased accuracy with which the groove is processed causes the component as a whole to be determined as a defective component even when there is no problem with the accuracy of the portion excluding the groove, resulting in a problem of a decrease in yield of the component. In addition, when a material that excels in thermal conductivity but is expensive is used to form the holding member to increase the amount of heat dissipated from the wavelength conversion member, it is necessary to use the expensive material to form the base member to be integrated with the holding member. That is, an excessive performance material is used to form the base member that does not require thermal conductivity higher than that of the holding member. In the case where the holding member and the base member are integrated with each other into a unit as described above, an optimum material and processing accuracy cannot be selected on a member basis, resulting in an increase in cost.

In view of the backgrounds described above, the persons who have disclosed the present disclosure have considered that the problem described above can be solved by forming the holding member having a groove and the base member to which a light source is fixed as separate members.

To this end, in the light source apparatus 100 according to the present embodiment, the base member 60 and the holding member 58 are configured as separate members.

The holding member 58 functions as a heat dissipation member as described above, and is therefore preferably made of a material having high thermal conductivity.

In the present embodiment, the thermal conductivity of the holding member 58 is higher than the thermal conductivity of the base member 60. The holding member 58 is made, for example, of an aluminum alloy such as A6061 having a thermal conductivity of 170 W/(m·k) (at 25° C.). The base member 60 is formed, for example, by die casting aluminum such as ADC12 having a thermal conductivity of 96 W/(m·k) (at 25° C.). According to the configuration described above, the heat of the wavelength conversion member 50 is efficiently transferred to the holding member 58, so that the amount of heat dissipated from the wavelength conversion member 50 can be increased.

In the light source apparatus 100 according to the present embodiment, the holding member 58, which holds the wavelength conversion member 50, can be made of a material that excels in thermal conductivity, and the base member 60 can be made of a material having relatively low thermal conductivity. That is, an optimum material can be used for each of the holding member 58 and the base member 60.

Furthermore, in the light source apparatus 100 according to the present embodiment, since the holding member 58 and the base member 60 are configured as separate members, the processing accuracy required for the groove 59 of the holding member 58 can be made different from the processing accuracy required for the base member 60. The yield of the holding member 58 therefore does not affect the yield of the base member 60, so that a decrease in the yield as a whole can be suppressed.

Therefore, the light source apparatus 100 according to the present embodiment, in which an optimum material and processing accuracy can be selected for each of the holding member 58 and the base member 60, allows suppression of an increase in cost, resulting in cost reduction.

The base member 60 includes a support section 560, spring fixing sections 540, a first housing section 541, a second housing section 542, a third housing section 543, a fourth housing section 544, a fifth housing section 545, a sixth housing section 546, and light source fixing sections 547.

The support section 560 is a recess that supports the holding member 58. The support section 560 restricts movement of the holding member 58 to both sides in the Z-axis direction. The pair of fixing members 64 fix the position of the holding member 58 with respect to the support section 560. One of the pair of fixing members 64 is disposed at a +X-side end portion of the holding member 58, and the other of the pair of fixing members 64 is disposed at a −X-side end portion of the holding member 58.

The support section 560 may include positioning pins that position the holding member 58 at a predetermined position.

In the present embodiment, the holding member 58 is supported by the support section 560 of the base member 60 via a thermally conductive member 66. Examples of the thermally conductive member 66 may include a thermally conductive adhesive and a thermally conductive grease. According to the configuration described above, since the holding member 58 and the support section 560 are coupled to each other via the thermally conductive member 66 in a heat transferable manner, the heat of the holding member 58 can be efficiently transferred toward the support section 560. Therefore, the heat transferred from the wavelength conversion member 50 to the holding member 58 can be dissipated to the support section 560 to further increase the amount of heat dissipated from the wavelength conversion member 50.

The fixing members 64 are each in contact with the −Y-side surface 58a of the holding member 58 supported by the support section 560, is disposed to extend in the direction along the Z-axis, and has opposite ends fixed to the base member 60, as shown in FIGS. 2 and 4. The fixing members 64 may each be configured with an elastic member such as a plate spring, or may be configured with a non-spring plate. A method for fixing the fixing members 64 to the base member 60 is not particularly limited to a specific method, and any of screwing, adhesion, and the like may be used.

The pair of fixing members 64 are thus supported by the support section 560 with the position of the holding member 58 in the Y-axis direction restricted.

Note in the present embodiment that the fixing members 64 each hold the holding member 58 from the −Y side of the support portion 560 toward the +Y side thereof, the holding member 58 may be pressed against the inner side surface of the support section 560 from the +Z side or the −Z side with springs or the like.

The position restrictors 65 restrict along with the first pressing members 90 the position of the wavelength conversion member 50 with respect to the base member 60. The position restrictors 65 restrict movement of the wavelength conversion member 50 in the Z-axis direction.

The position restrictors 65 hold the first protrusion 151 and the second protrusion 152, which protrudes from the groove 59 of the holding member 58, to restrict the position of the first protrusion 151 and the second protrusion 152 with respect to the groove 59. The position restrictors 65 include a pair of restriction members 651 and 652, which hold the first protrusion 151, and a pair of restriction members 653 and 654, which hold the second protrusion 152.

The restriction member 651, which is one of the restriction members 651 and 652, which hold the first protrusion 151, is fixed to the third housing section 543 with a screw 97, and the restriction member 652, which is the other of the restriction members 651 and 652, is fixed to the fourth housing section 544 with another screw 97. The restriction member 653, which is one of the restriction members 653 and 654, which hold the second protrusion 152, is fixed to the fifth housing section 545 with a screw 97, and the restriction member 654, which is the other of the restriction members 653 and 654, is fixed to the sixth housing section 546 with another screw 97.

Note that the positions of the pair of restriction members 651 and 652 with respect to each other in the Z-axis direction are adjustable by an adjustment mechanism that is not shown. Similarly, the positions of the pair of restriction members 653 and 654 with respect to each other in the Z-axis direction are adjustable by an adjustment mechanism that is not shown.

The wavelength conversion member 50 in the present embodiment is thus held in the groove 59 with the movement of the first protrusion 151 and the second protrusion 152, which protrude outward from the groove 59, restricted in the Z-axis direction by the position restrictors 65.

The substrate 55 of the first light source section 51 is fixed to the light source fixing sections 547 of the base member 60 via, for example, screw members.

The first pressing members 90 restrict the position of the wavelength conversion member 50 in the Y-axis direction with respect to the holding member 58 in the groove 59. The first pressing members 90 are disposed to face a support surface 59s of the groove 59. The thus disposed first pressing members 90 restrict movement of the wavelength conversion member 50 in the Y-axis direction in the groove 59. The first pressing members 90 are made of an elastically deformable material. As an example, the first pressing members 90 are each configured with a plate spring made of a metal material, for example, stainless steel such as SUS304.

In the present embodiment, the two first pressing members 90 are each desirably disposed at a position where the first pressing members 90 do not overlap with the light emitters 56 of the first light source section 51.

The first pressing members 90 press the wavelength conversion member 50 against the support surface 59s of the groove 59. The first pressing members 90 are fixed to the base member 60.

The mirror 53 is disposed at the sixth surface 50f of the wavelength conversion member 50. The mirror 53 reflects the fluorescence Y having been guided through the interior of the wavelength conversion member 50 and having reached the sixth surface 50f. The mirror 53 is configured with a metal film or a dielectric multilayer film formed at the sixth surface 50f of the wavelength conversion member 50.

The spring fixing sections 540 are disposed at opposite sides of the groove 59 in the Z-axis direction along the transverse direction of the wavelength conversion member 50. The spring fixing sections 540 fix opposite end portions of the first pressing members 90 disposed to extend over the wavelength conversion member 50 in the Z-axis direction with screws 96.

The first housing section 541 is a recess that communicates with the +X-direction side of the groove 59. The first housing section 541 passes through the base member 60 to an outer edge 60d thereof. The first housing section 541 houses the first protrusion 151 of the wavelength conversion member 50, which protrudes from the groove 59. The first housing section 541 holds the angle conversion member 52 fixed to the fifth surface 50e of the wavelength conversion member 50. In the present embodiment, the angle conversion member 52 fixed to the fifth surface 50e of the first protrusion 151 is held by the base member 60.

A light exiting surface 52b of the angle conversion member 52 housed in the first housing section 541 is flush with the outer edge 60d of the base member 60 in the plan view.

The second housing section 542 is a recess that communicates with the −X-direction side of the groove 59. The second housing section 542 passes through the base member 60 to the outer edge 60d thereof. The second housing section 542 houses the second protrusion 152 of the wavelength conversion member 50, which protrudes from the groove 59. In the present embodiment, the mirror 53 is provided at the sixth surface 50f of the second protrusion 152. The second housing section 542 houses the mirror 53 provided at the sixth surface 50f of the wavelength conversion member 50.

The second pressing member 91 presses the mirror 53 housed in the second housing section 542 from the side facing an outer surface 53t toward the sixth surface 50f of the wavelength conversion member 50. A reflection surface 53r of the mirror 53 thus comes into close contact with the sixth surface 50f of the wavelength conversion member 50. The second pressing member 91 includes a pressing section 911 and an elastic section 912. The second pressing member 91 is made of a plate-shaped metal material producing an elastic force, and the pressing section 911 and the elastic section 912 are integrated with each other into a unit. According to the configuration described above, the pressing section 911 can reliably press the mirror 53, and the elastic section 912 can apply a pressing force to the pressing section 911. The pressing section 911 is in contact with the outer surface 53t of the mirror 53 and presses the mirror 53.

The third housing section 543 is a recess that communicates with the +Z-direction side of the first housing section 541. The third housing section 543 houses the restriction member 651 of the position restrictors 65, which holds the +Z side of the first protrusion 151 of the wavelength conversion member 50, which is housed in the first housing section 541.

The fourth housing section 544 is a recess that communicates with the −Z-direction side of the first housing section 541. The fourth housing section 544 houses the restriction member 652 of the position restrictors 65, which holds the −Z side of the first protrusion 151 of the wavelength conversion member 50, which is housed in the first housing section 541.

The fifth housing section 545 is a recess that communicates with the +Z-direction side of the second housing section 542. The fifth housing section 545 houses the restriction member 653 of the position restrictors 65, which holds the +Z side of the second protrusion 152 of the wavelength conversion member 50, which is housed in the second housing section 542.

The sixth housing section 546 is a recess that communicates with the −Z-direction side of the second housing section 542. The sixth housing section 546 houses the restriction member 654 of the position restrictors 65, which holds the −Z side of the second protrusion 152 of the wavelength conversion member 50, which is housed in the second housing section 542.

In the first illuminator 20, when the excitation light E output from the first light source section 51 enters the wavelength conversion member 50, the phosphor contained in the wavelength conversion member 50 is excited, and the fluorescence Y is emitted from random light emission points. The fluorescence Y travels omnidirectionally from the random light emission points, and the fluorescence Y directed toward the four side surfaces 50a, 50b, 50c, and 50d travels toward the fifth surface 50e or the sixth surface 50f while being repeatedly totally reflected at multiple locations on the side surfaces 50a, 50b, 50c, and 50d. The fluorescence Y is guided and propagates through the interior of the wavelength conversion member 50 while being totally reflected, and exits via the fifth surface 50e. In the present embodiment, the fluorescence Y traveling toward the fifth surface 50e enters the angle conversion member 52 provided at the fifth surface 50e. The fluorescence Y traveling toward the sixth surface 50f is reflected off the mirror 53 and travels toward the fifth surface 50e.

Out of the excitation light E having entered the wavelength conversion member 50, part of the excitation light E that has not been used to excite the phosphor is reflected off members around the wavelength conversion member 50, including the light emitters 56 of the first light source section 51, or the mirror 53 provided at the sixth surface 50f. The part of the excitation light E is therefore confined in the wavelength conversion member 50 and reused.

The angle conversion member 52 is provided at the fifth surface 50e of the wavelength conversion member 50. The angle conversion member 52 is configured, for example, with a tapered rod. The angle conversion member 52 has a light incident surface 52a, on which the fluorescence Y output from the wavelength conversion member 50 is incident, the light exiting surface 52b, via which the fluorescence Y exits, and a side surface 52c, which reflects the incident fluorescence Y toward the light exiting surface 52b.

The angle conversion member 52 has a truncated quadrangular pyramidal shape, and the cross-sectional area perpendicular to an optical axis J of the angle conversion member 52 widens along the light traveling direction. The area of the light exiting surface 52b is therefore greater than the area of the light incident surface 52a. The optical axis J of the angle conversion member 52 is an axis passing through the centers of the light exiting surface 52b and the light incident surface 52a, and is parallel to the X-axis. The optical axis J of the angle conversion member 52 coincides with the optical axis AX1 of the first illuminator 20.

The fluorescence Y having entered the angle conversion member 52 changes its orientation while traveling through the interior of the angle conversion member 52 in such a way that the direction of the fluorescence Y approaches the direction parallel to the optical axis J whenever the fluorescence Y is totally reflected off the side surface 52c. The angle conversion member 52 thus converts the exiting angle distribution of the fluorescence Y output via the fifth surface 50e of the wavelength conversion member 50. Specifically, the angle conversion member 52 makes the largest exiting angle of the fluorescence Y at the light exiting surface 52b smaller than the largest incident angle of the fluorescence Y at the light incident surface 52a.

In general, since the etendue of light specified by the product of the area of a light exiting region and the largest exiting angle, which is the solid angle of the light, is preserved, the etendue of the fluorescence Y is preserved before and after the fluorescence Y passes through the angle conversion member 52. The angle conversion member 52 has the configuration in which the area of the light exiting surface 52b is greater than the area of the light incident surface 52a as described above. The angle conversion member 52 can therefore make the largest exiting angle of the fluorescence Y at the light exiting surface 52b smaller than the largest incident angle of the fluorescence Y at the light incident surface 52a from the viewpoint of the etendue preservation.

The angle conversion member 52 is fixed to the wavelength conversion member 50 via an optical adhesive that is not shown so that the light incident surface 52a faces the fifth surface 50e of the wavelength conversion member 50. That is, the angle conversion member 52 and the wavelength conversion member 50 are in contact with each other via the optical adhesive, and an air gap such as an air layer is not disposed between the angle conversion member 52 and the wavelength conversion member 50. When an air gap is provided between the angle conversion member 52 and the wavelength conversion member 50, the fluorescence Y incident on the light incident surface 52a of the angle conversion member 52 at angles greater than or equal to the critical angle out of the fluorescence Y having reached the light incident surface 52a is totally reflected off the light incident surface 52a and cannot enter the angle conversion member 52. In contrast, when no air gap is provided between the angle conversion member 52 and the wavelength conversion member 50 as in the present embodiment, the amount of lost component of the fluorescence Y that cannot enter the angle conversion member 52 due to the total reflection can be reduced. It is desirable from the viewpoint described above that the refractive index of the angle conversion member 52 matches as much as possible with the refractive index of the wavelength conversion member 50.

As the angle conversion member 52, a compound parabolic concentrator (CPC) may be used in place of a tapered rod. Even when a CPC is used as the angle conversion member 52, the same advantages as those provided when the tapered rod is used can be provided. Note that the light source apparatus 100 may not necessarily include the angle conversion member 52.

A parallelizing system 73, which is configured, for example, with a collimator lens, is provided between the light source apparatus 100 and the optical integration system 70. The parallelizing system 73 further narrows the angular distribution of the fluorescence Y output from the angle conversion member 52 and causes the resultant fluorescence Y having a high degree of parallelism to enter the optical integration system 70. Note that the parallelizing system 73 may not be provided when the fluorescence Y output from the angle conversion member 52 has a sufficiently high degree of parallelism.

The optical integration system 70 includes a first lens array 71 and a second lens array 72. The optical integration system 70, along with the superimposing system 103, functions as an illumination homogenizing system that homogenizes the intensity distribution of the fluorescence Y output from the light source apparatus 100 at each of the light modulators 4R and 4G, which are illumination receiving regions. The fluorescence Y output from the parallelizing system 73 enters the first lens array 71. The first lens array 71, along with the second lens array 72 provided at a position downstream from a first lens array 71, forms the optical integration system 70.

The first lens array 71 includes multiple first lenslets 71a. The multiple first lenslets 71a are arranged in a matrix in a plane parallel to the YZ plane perpendicular to the optical axis AX1 of the first illuminator 20. The multiple first lenslets 71a divide the fluorescence Y output from the angle conversion member 52 into multiple sub-luminous fluxes. The first lenslets 71a each have a rectangular shape substantially similar to the shape of the image formation region of each of the light modulators 4R and 4G. The sub-luminous fluxes output from the first lens array 71 are each thus efficiently incident on the image formation region of each of the light modulators 4R and 4G.

The fluorescence Y output from the first lens array 71 travels toward the second lens array 72. The second lens array 72 is disposed to face the first lens array 71. The second lens array 72 includes multiple second lenslets 72a corresponding to the multiple first lenslets 71a of the first lens array 71. The second lens array 72 along with the superimposing system 103 brings images of the multiple first lenslets 71a of the first lens array 71 into focus in the vicinity of the image formation region of each of the light modulators 4R and 4G. The multiple second lenslets 72a are arranged in a matrix in a plane parallel to the YZ plane perpendicular to the optical axis AX1 of the first illuminator 20.

In the present embodiment, the first lenslets 71a of the first lens array 71 and the second lenslets 72a of the second lens array 72 have the same size, and may instead have sizes different from each other. In the present embodiment, the first lenslets 71a of the first lens array 71 and the second lenslets 72a of the second lens array 72 are so disposed that the optical axes thereof coincide with each other, and may instead be so disposed that the optical axes thereof deviate from each other.

The polarization converter 102 converts the polarization direction of the fluorescence Y output from the second lens array 72. Specifically, the polarization converter 102 converts each of the sub-luminous fluxes into which the fluorescence Y has been divided by the first lens array 71 and which are then output from the second lens array 72 into linearly polarized light.

The polarization converter 102 includes polarization separation layers that are not shown but directly transmit one of the linearly polarized components contained in the fluorescence Y output from the light source apparatus 100 and reflect another one of the linearly polarized components in a direction perpendicular to the optical axis AX1, reflection layers that are not shown but reflect the other linearly polarized component reflected off the polarization separation layers in the direction parallel to the optical axis AX1, and phase retarders that are not shown but convert the other linearly polarized component reflected off the reflection layers into the one linearly polarized component.

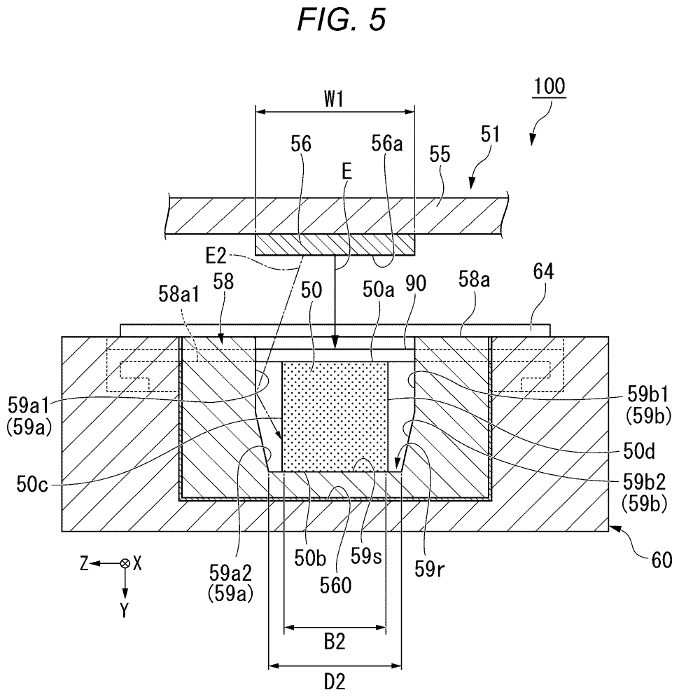

FIG. 5 is a cross-sectional view of the light source apparatus 100 taken along the line V-V in FIG. 4.

The surface 58a of the holding member 58 is located above (at level shifted toward-Y side from) the first surface 50a of the wavelength conversion member 50 held in the groove 59, as shown in FIG. 5. The fixing members 64 in contact with the surface 58a of the holding member 58 therefore are not in contact with the first surface 50a of the wavelength conversion member 50. The first pressing members 90, which are disposed in slit-shaped recesses 58al shown in FIG. 4 provided in the surface 58a of the holding member 58, are in contact with the first surface 50a of the wavelength conversion member 50.

The groove 59 of the holding member 58 has a U-shaped cross section perpendicular to the X-axis direction, and has an elongated shape extending in the X-axis direction.

The groove 59 has the support surface 59s, which supports the second surface 50b of the wavelength conversion member 50, and a first sidewall surface 59a and a second sidewall surface 59b, which intersect with the support surface 59s.

The support surface 59s is a surface that extends in parallel to the XZ plane and constitutes the bottom surface of the groove 59, which holds the wavelength conversion member 50. The support surface 59s supports the second surface 50b of the wavelength conversion member 50. The first sidewall surface 59a and the second sidewall surface 59b are planar surfaces that extend along the XY plane and face opposite sides.

The first sidewall surface 59a corresponds to one side surface of the groove 59, faces the third surface 50c of the wavelength conversion member 50, and is separate from the third surface 50c. That is, a gap is provided between the first sidewall surface 59a and the third surface 50c of the wavelength conversion member 50. The second sidewall surface 59b corresponds to the other side surface of the groove 59, faces the fourth surface 50d of the wavelength conversion member 50, and is separate from the fourth surface 50d. That is, a gap is provided between the second sidewall surface 59b and the fourth surface 50d of the wavelength conversion member 50.

The first sidewall surface 59a includes a first section 59al located at a side facing the first surface 50a, and a second section 59a2 located at a side facing the support surface 59s. The first section 59al extends in the direction perpendicular to the support surface 59s, that is, in parallel to the XY plane. The second section 59a2 inclines so as to approach the third surface 50c as extending from the side facing the first section 59a1 toward the support surface 59s. In other words, the distance between the third surface 50c and the second section 59a2 facing the support surface 59s is smaller than the distance between the third surface 50c and the second section 59a2 facing the first section 59a1.

The second sidewall surface 59b includes a third section 59b1, which is located at the side facing the first surface 50a, and a fourth section 59b2, which is located at the side facing the support surface 59s. The third section 59b1 extends in the direction perpendicular to the support surface 59s, that is, in parallel to the XY plane. The fourth section 59b2 inclines so as to approach the fourth surface 50d as extending from the side facing the third section 59b1 toward the support surface 59s. In other words, the distance between the fourth surface 50d and the fourth section 59b2 facing the support surface 59s is smaller than the distance between the fourth surface 50d and the fourth section 59b2 facing the third section 59b1.

The first sidewall surface 59a, the second sidewall surface 59b, and the support surface 59s, which constitute the inner surface of the groove 59, are each configured with a surface of the aluminum alloy, of which the holding member 58 is made. More specifically, the first sidewall surface 59a, the second sidewall surface 59b, and the support surface 59s are each configured with a processed surface that is the aluminum alloy surface described above on which a mirror finishing treatment has been performed. Therefore, the first sidewall surface 59a, the second sidewall surface 59b, and the support surface 59s each have light reflectivity and reflect the excitation light E incident thereon. Note that the first sidewall surface 59a, the second sidewall surface 59b, and the support surface 59s may instead be each configured with a film made of another metal or a dielectric multilayer film formed at the aluminum alloy surface.

Since the first sidewall surface 59a and the second sidewall surface 59b of the groove 59 need to go through mirror finishing as described above, the holding member 58, which forms the groove 59, needs to be processed with high processing accuracy. The light source apparatus 100 according to the present embodiment, in which the holding member 58 is a component separate from the base member 60 as described above, readily allows enhancement in processability and processing accuracy of the first sidewall surface 59a and the second sidewall surface 59b of the groove 59.

A dimension W1, along the Z-axis direction, of the light emission surface 56a of each of the light emitters 56 is greater than a width B2, along the Z-axis direction, of the wavelength conversion member 50. Note that the width, in the Z-axis direction, of the wavelength conversion member 50 in the present embodiment is uniform over the entire length in the longitudinal direction.

Opposite end portions of the light emission surface 56a of each of the light emitters 56 therefore extend off the third 50c of the wavelength conversion member 50 in the Z-axis direction. Specifically, the opposite end portions of the light emission surface 56a of each of the light emitters 56 extend off to positions where one of the opposite end portions overlaps with the gap between the third surface 50c and the first sidewall surface 59a and the other opposite end portion overlaps with the gap between the fourth surface 50d and the second sidewall surface 59b. In other words, when the light emission surface 56a is viewed from the side facing the support surface 59s along the Y-axis direction, a portion of the light emission surface 56a coincides with the first surface 50a, and the other portion of the light emission surface 56a overlaps with the gap between the third surface 50c and the first sidewall surface 59a and the gap between the fourth surface 50d and the second sidewall surface 59b.

A first width D2, along the Z-axis direction, of the support surface 59s of the groove 59 is greater than the width B2, along the Z-axis direction, of the wavelength conversion member 50. Opposite end portions of the support surface 59s therefore extend off the second surface 50b of the wavelength conversion member 50 in the Z-axis direction. In other words, when the support surface 59s is viewed from the side facing the light emission surface 56a along the Y-axis direction, a portion of the support surface 59s coincides with the second surface 50b, and the other portion of the support surface 59s is exposed to the space outside the second surface 50b. The support surface 59s thus has an exposed section 59r exposed to the space outside the wavelength conversion member 50.

In the light source apparatus 100 according to the present embodiment, excitation light E2, which is part of the excitation light E output via the light emission surface 56a of each of the light emitters 56, passes through the gap between the third surface 50c of the wavelength conversion member 50 and the first section 59a1, and is then incident on the second section 59a2, which inclines with respect to the support surface 59s. In this process, the excitation light E2 is reflected off the second section 59a2 and incident on the third surface 50c of the wavelength conversion member 50. The excitation light E2 passing through the gap between the third surface 50c of the wavelength conversion member 50 and the first sidewall surface 59a is thus likely to be incident on the third surface 50c, so that the amount of excitation light E that is reflected off the support surface 59s and returns toward the first light source section 1 can be reduced. Furthermore, part of the excitation light E is reflected off the first section 59a1, which extends in the direction perpendicular to the support surface 59s, and is incident on the third surface 50c of the wavelength conversion member 50. Similarly, the excitation light E having entered the gap between the fourth surface 50d of the wavelength conversion member 50 and the second sidewall surface 59b is reflected off the third section 59b1 or the fourth section 59b2, and is incident on the fourth surface 50d of the wavelength conversion member 50.

The light source apparatus 100 according to the present embodiment can thus efficiently use the excitation light E and generate fluorescence Y having desired intensity.

As described above, the light source apparatus 100 according to the present embodiment includes the light emitters 56, which emit the excitation light E, the substrate 55, which supports the light emitters 56, the wavelength conversion member 50, which the excitation light E emitted from the light emitters 56 enters, the holding member 58, which includes the groove 59, which holds at least a portion of the wavelength conversion member 50, and the base member 60, which is configured with a member separate from the holding member 58 and fixes the substrate 55. The holding member 58 is supported by the base member 60.

In the light source apparatus 100 according to the present embodiment, since the holding member 58 and the base member 60 are configured as separate members, the processing accuracy required for the groove 59 of the holding member 58 can be made different from the processing accuracy required for the base member 60. The yield of the holding member 58 therefore does not affect the yield of the base member 60, so that a decrease in the yield of the light source apparatus as a whole can be suppressed.

The light source apparatus 100 according to the present embodiment, in which an optimum material and processing accuracy can be selected for each of the holding member 58 and the base member 60, therefore allows cost reduction.

Furthermore, in the light source apparatus 100 according to the present embodiment, the holding member 58, which holds the wavelength conversion member 50, can be made of a material that excels in thermal conductivity, so that the performance of cooling the wavelength conversion member 50 can be enhanced. In addition, since the groove 59, which holds the wavelength conversion member 50, has a high degree of surface accuracy, the second surface 50b of the wavelength conversion member 50 is held in the groove 59 with the second surface 50b being in satisfactorily close contact with the support surface 59s. The heat generated in the wavelength conversion member 50 is therefore efficiently transferred to the holding member 58 via the support surface 59s. Accordingly, the light source apparatus 100 according to the present embodiment, in which the amount of heat dissipated from the wavelength conversion member 50 can be increased, can output bright fluorescence Y from the wavelength conversion member 50.

Since the projector 1 according to the present embodiment includes the light source apparatus 100, which generates the bright fluorescence Y generated through selection of an optimum material and processing accuracy, can be a projector using light at excellent efficiency and achieved at low cost.

### Second Embodiment

A light source apparatus according to a second embodiment will be described below. The difference between the present embodiment and the first embodiment is the structure for supporting the holding member in the base member. In the following description, the support structure will be primarily described, and members common to those in the first embodiment have the same reference characters, and will not be described or will be described in a simplified manner.

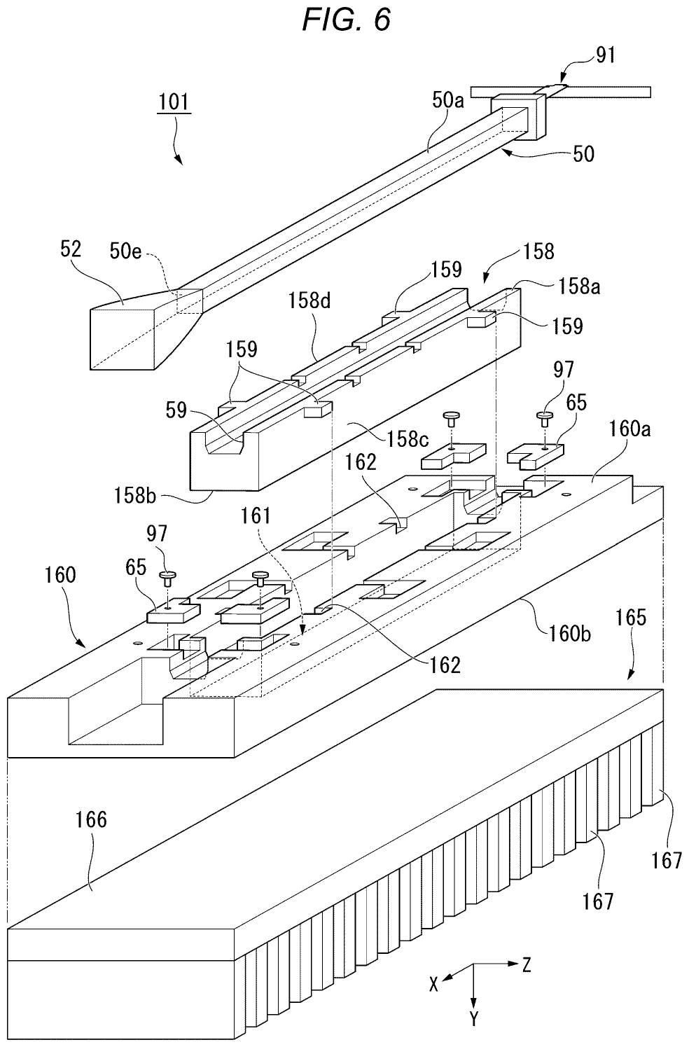

FIG. 6 is an exploded perspective view showing the configuration of key portions of a light source apparatus 101 according to the present embodiment. In FIG. 6, the light source section that is not related to the description is not shown for clarity of the figure.

In the light source apparatus 101 according to the present embodiment, a base member 160 has a front surface 160a, to which the substrate 55 of the first light source section 51 is fixed, a rear surface 160b, which faces the side opposite from the front surface 160a, a through hole 161, which passes through the front surface 160a and the rear surface 160b, and cutouts 162, which are provided in the front surface 160a and communicate with the through hole 161, as shown in FIG. 6.

The light source apparatus 101 according to the present embodiment further includes a heat dissipation member 165 disposed at a side facing the rear surface 160b of the base member 160. The heat dissipation member 165 constitutes a heat sink including a heat dissipation substrate 166 and multiple heat dissipation fins 167. The heat dissipation substrate 166 is configured witha substrate made of metal that excels in heat dissipation, for example, aluminum and copper. The heat dissipation substrate 166 has the same outer shape as the base member 160, and is bonded to the rear surface 160b of the base member 160. The multiple heat dissipation fins 167 are provided at a surface of the heat dissipation substrate 166 that is the surface opposite from the base member 160.

The heat dissipation member 165 and the rear surface 160b of the base member 160 may be in direct contact with each other, or may be in indirect contact with each other via a thermally conductive adhesive, thermally conductive beads, or the like.

A holding member 158 in the present embodiment is supported by the through hole 161 in the base member 160. The holding member 158 is inserted into the through hole 161, and a first side surface 158c and a second side surface 158d perpendicular to a front surface 158a and a rear surface 158b are in contact with the inner wall surface of the through hole 161. The contact area between the holding member 158 and the base member 160 therefore increases, and the heat of the holding member 158 is dissipated toward the base member 160, so that the performance of cooling the wavelength conversion member 50 can be enhanced.

Note that the heat of the holding member 158 may be efficiently transferred toward the base member 160 by disposing a thermally conductive adhesive or thermally conductive fillers between the first side surface 158c and the inner wall surface of the through hole 161 and between the second side surface 158d and the inner wall surface of the through hole 161.

The holding member 158 has protrusions 159 to be fixed to the cutouts 162. The protrusions 159 are disposed at opposite sides of the groove 59 of the holding member 158 in the Z-axis direction. Specifically, the protrusions 159 include a pair of protrusions 159 provided at −Y-side end portions of the first side surface 158c perpendicular to the front surface 158a and the rear surface 158b of the holding member 158, and another pair of protrusions 159 provided at −Y-side end portions of the second side surface 158d perpendicular thereto. The holding member 158 therefore has four protrusions 159 in total.

In the present embodiment, the protrusions 159 are fitted into the cutouts 162 from the −Y side toward the +Y side and fixed therein. The holding member 158 is thus fixed to the base member 160 while being supported by the through hole 161. A method for fixing the protrusions 159 to the cutouts 162 is not limited to the fitting, and may be adhesion or screw fixing.

In the state in which the protrusions 159 are fixed into the cutouts 162, the rear surface 158b of the holding member 158 is exposed to the space facing the rear surface 160b of the base member 160. In the present embodiment, the rear surface 158b of the holding member 158 is flush with the rear surface 160b of the base member 160. The heat dissipation member 165 is thermally coupled to the rear surface 158b of the holding member 158 supported by the through hole 161 and exposed to the space facing the rear surface 160b. The state in which the heat dissipation member 165 is thermally coupled to the rear surface 158b of the holding member 158 may include a state in which the heat dissipation member 165 is in direct contact with the rear surface 158b, or a state in which a heat conductive adhesive, heat conductive beads, or the like is disposed between the heat dissipation member 165 and the rear surface 158b as long as the heat can be conducted from the rear surface 158b to the heat dissipation member 165.

The light source apparatus 101 according to the present embodiment, in which h an optimum material and processing accuracy can be selected for each of the holding member 158 and the base member 160, allows cost reduction, as in the first embodiment. Furthermore, fixing the protrusions 159 of the holding member 158 into the cutouts 162 allows the holding member 158 to be readily fixed to the base member 160. Moreover, providing the heat dissipation member 165 thermally coupled to the holding member 158 allows the heat of the holding member 158 to be efficiently dissipated. The efficiency at the wavelength conversion member 50 is cooled is thus increased, so that bright fluorescence Y can be generated.

The present embodiment has been described with reference to the case where the protrusions 159 are fixed into the cutouts 162 to fix the holding member 158 to the base member 160, and the holding member 158 exposed via the through hole 161 to the space facing the rear surface 160b of the base member 160 may be fixed to the heat dissipation member 165. The configuration described above, in which the protrusions 159 and the cutouts 162 are unnecessary, can simplify the configuration of the holding member 158 and the configurations around the groove 59 of the base member 160.

Note that the technical scope of the present disclosure is not limited to the embodiments described above, and a variety of changes can be made thereto without departing from the intent of the present disclosure.

For example, the wavelength conversion member 50 in the embodiments described above is formed in a quadrangular prismatic shape extending along the X-axis and having six surfaces, and the angle conversion member 52 is provided at the fifth surface 50e, which is the light exiting portion, and a light exiting portion having a truncated quadrangular pyramidal shape may be formed at and integrated with the light-exiting-side end of the wavelength conversion member 50 to omit the angle conversion member 52.

In the embodiments described above, the wavelength conversion member 50 is so disposed in the groove 59 that the third surface 50c and the fourth surface 50d are separate from the first sidewall surface 59a and the second sidewall surface 59b, respectively, and the third surface 50c or the fourth surface 50d of the wavelength conversion member 50 may be in contact with the first sidewall surface 59a or the second sidewall surface 59b. The configuration described above, in which the contact area between the wavelength conversion member and the holding member increases, can further increase the amount of heat dissipated from the wavelength conversion member.

In the embodiments described above, the first sidewall surface 59a and the second sidewall surface 59b of the groove 59 each have a portion perpendicular to the support surface 59s and a portion inclining with respect to the support surface 59s, but the groove 59 does not necessarily have a specific shape. For example, all the regions of the wall surfaces of the groove may be perpendicular to the support surface. The wall surfaces of the groove may be curved.

The aforementioned embodiments have been described with reference to the case where the present disclosure is applied to the light source apparatus including the wavelength conversion member. In place of the configuration described above, the present disclosure may be applied to a light source apparatus in which the light having entered the light source apparatus propagates without being converted in terms of wavelength and then exits out of the light source apparatus, for example, with the angular distribution controlled. In this case, the wavelength conversion member in the embodiments described above is replaced with a light guide member, and the light emitted from the light emitters exits out of the angle conversion member as light having the same wavelength band.

In addition, the specific descriptions of the shapes, the numbers, the arrangements, the materials, and other factors of the elements of the light source apparatus and the projector are not limited to those in the embodiments described above and can be changed as appropriate. The aforementioned embodiments have been described with reference to the case where the light source apparatus according to the present disclosure is incorporated in a projector using liquid crystal panels, but not necessarily. The light source apparatus according to the present disclosure may be incorporated in a projector using digital micromirror devices as the light modulators. The projector may not include multiple light modulators and may instead include only one light modulator.

The aforementioned embodiments have been described with reference to the case where the wavelength conversion member 50 is pressed against the holding member 58 by the two first pressing members 90, but the number of first pressing members 90 is not limited thereto. For example, when an enough amount of excitation light E that enters the wavelength conversion member 50 from the light emitters 56 can be secured, three or more first pressing members 90 may be provided.

The aforementioned embodiments have been described with reference to the case where the light source apparatus according the to present disclosure is incorporated in a projector, but not necessarily. The light source apparatus according to the present disclosure may be incorporated in a lighting apparatus, a headlight of an automobile, and other apparatuses.

The present disclosure will be summarized below as additional remarks.

### Additional Remark 1

A light source apparatus including:
a light emitter configured to emit light;
a substrate configured to support the light emitter;
a light guide member that the light emitted from the light emitter enters;
a holding member having a groove configured to hold at least a portion of the light guide member; and
a base member configured as a member separate from the holding member and to which the substrate is fixed,
wherein the holding member is supported by the base member.

According to the thus configured light source apparatus, since the holding member and the base member are configured as separate members, the processing accuracy required for the groove of the holding member can be made different from the processing accuracy required for the base member. The yield of the holding member therefore does not affect the yield of the base member, so that a decrease in the yield of the light source apparatus as a whole can be suppressed.

The thus configured light source apparatus, in which an optimum material and processing accuracy can be selected for each of the holding member and the base member, therefore allows cost reduction.

Furthermore, the thus configured light source apparatus, in which the holding member, which holds the light guide member, can be made of a material that excels in thermal conductivity, can enhance the performance of cooling the light guide member. In addition, since the groove, which holds the light guide member, has a high degree of surface accuracy, the light guide member and the support surface of the groove are in satisfactorily close contact with each other, so that the heat of the light guide member is efficiently transferred to the holding member. The thus configured light source apparatus can therefore further enhance the heat dissipation capability of the light guiding member, and can hence output bright light from the light guide member.

### Additional Remark 2

The light source apparatus according to the additional remark 1, wherein
at least a portion of an inner surface of the groove reflects the light emitted from the light emitter toward the light guide member.

According to the configuration described above, the light emitted from the light emitter is efficiently caused to enter the light guide member, so that the light can be used at further increased efficiency.

### Additional Remark 3

The light source apparatus according to the additional remark 2, wherein
the light guide member has a first surface on which the light is incident, a second surface facing a side opposite from the first surface, a third surface and a fourth surface that intersect with the first surface and the second surface and face opposite sides, and a light exiting portion via which the light exits,
the groove has a support surface facing the second surface, a first sidewall surface facing the third surface and separate from the third surface, and a second sidewall surface facing the fourth surface and separate from the fourth surface,
the first sidewall surface includes a first section located at a side facing the first surface and a second section located at a side facing the support surface, the first section extending in a direction perpendicular to the support surface, the second section inclining so as to approach the third surface as extending from the side facing the first section toward the support surface,
the second sidewall surface includes a third section located at a side facing the first surface and a fourth section located at a side facing the support surface, the third section extending in the direction perpendicular to the support surface, the fourth section inclining so as to approach the fourth surface as extending from the side facing the third section toward the support surface, and
the first, the second, the third, and the fourth sections reflect at least part of the light.

According to the configuration described above, part of the light emitted from the light emitter travels through the gap between the third surface of the light guide member and the first section, and is then incident on the second section inclining with respect to the support surface. At this point of time, the light is reflected off the second section and incident on the third surface of the light guide member. As described above, the light passing through the gap between the third surface of the light guide member and the first section surface is readily incident on the third surface, so that the amount of light reflected off the support surface and returning toward the light emitter can be reduced. Furthermore, part of the light is reflected off the first section, which extends in the direction perpendicular to the support surface, and is incident on the third surface of the light guide member.

Similarly, part of the light emitted from the light emitter travels through the gap between the fourth surface of the light guide member and the third section, and is then incident on the fourth section inclining with respect to the support surface. At this point of time, the light is reflected off the fourth section and incident on the fourth surface of the light guide member. As described above, the light passing through the gap between the fourth surface of the light guide member and the second section surface is readily incident on the fourth surface, so that the amount of light reflected off the support surface and returning toward the light emitter can be reduced. Furthermore, part of the light is reflected off the third section, which extends in the direction perpendicular to the support surface, and is incident on the fourth surface of the light guide member.

The light source apparatus achieved in accordance with the additional remark 3 can therefore efficiently use the light and readily generate light having desired intensity.

### Additional Remark 4

The light source apparatus according to any one of the additional remarks 1 to 3, wherein
the base member has a recess configured to support the holding member.

According to the configuration described above, providing the holding member with the recess allows the holding member and the base member to be readily aligned with each other.

### Additional Remark 5

The light source apparatus according to any one of the additional remarks 1 to 4, wherein
thermal conductivity of the holding member is higher than thermal conductivity of the base member.

According to the configuration described above, heat can be efficiently dissipated from the light guide member held by the holding member.

### Additional Remark 6

The light source apparatus according to any one of the additional remarks 1 to 5, wherein
the holding member is supported by the base member via a thermally conductive member.

According to the configuration described above, the heat of the holding member is efficiently dissipated toward the base member via the thermally conductive member, so that the performance of cooling the light guide member can be enhanced.

### Additional Remark 7

The light source apparatus according to any one of the additional remarks 1 to 6, wherein
the base member has a front surface to which the substrate is fixed, a rear surface facing a side opposite from the front surface, and a through hole passing the front surface and the rear surface, and
the holding member is supported by the through hole in the base member.

According to the configuration described above, the contact area between the holding member and the base member increases, and the heat of the holding member is dissipated toward the base member, so that the performance of cooling the light guide member can be enhanced.

### Additional Remark 8

The light source apparatus according to any one of the additional remarks 1 to 7,
further comprising a heat dissipation member disposed at a side facing the rear surface of the base member,
wherein the heat dissipation member is thermally coupled to the holding member supported by the through hole and exposed to a space facing the rear surface.

According to the configuration described above, which includes the heat dissipation member thermally coupled to the holding member, the heat of the holding member can be efficiently dissipated. The efficiency at which the light guide member is cooled is therefore increased, so that bright light can be generated.

### Additional Remark 9

The light source apparatus according to any one of the additional remarks 1 to 8, wherein
the base member further has a cutout provided in the front surface and communicating with the through hole, and
the holding member has a protrusion fixed into the cutout.

According to the configuration described above, fixing the protrusion of the holding member into the cutout allows the holding member to be readily fixed to the base member.

### Additional Remark 10

The light source apparatus according to any one of the additional remarks 1 to 9, wherein
the light emitter emits first light having a first wavelength band, and
the light guide member is a wavelength conversion member that contains a phosphor, and is configured to convert the first light emitted from the light emitter into second light having a second wavelength band different from the first wavelength band and output the second light.

According to the configuration described above, since the wavelength conversion member is efficiently cooled, a light source apparatus configured to generate second light having a desired intensity can be realized at low cost.

### Additional Remark 11

A projector including:
the light source apparatus according to any one of the additional remarks 1 to 10;
a light modulator configured to modulate light output from the light source apparatus in accordance with image information; and
a projection optical apparatus configured to project the light modulated by the light modulator.

The thus configured projector includes the light source apparatus described above, which generates bright light generated through selection of an optimum material and processing accuracy, and can therefore be a projector that uses light at excellent efficiency and is realized at low cost.

What is claimed is:

1. A light source apparatus comprising:
a light emitter configured to emit light;
a substrate configured to support the light emitter;
a light guide member that the light emitted from the light emitter enters;
a holding member having a groove configured to hold at least a portion of the light guide member; and
a base member configured as a member separate from the holding member and to which the substrate is fixed,
wherein the holding member is supported by the base member.

2. The light source apparatus according to claim 1, wherein
at least a portion of an inner surface of the groove reflects the light emitted from the light emitter toward the light guide member.

3. The light source apparatus according to claim 2, wherein
the light guide member has a first surface on which the light is incident, a second surface facing a side opposite from the first surface, a third surface and a fourth surface that intersect with the first surface and the second surface and face opposite sides, and a light exiting portion via which the light exits,
the groove has a support surface facing the second surface, a first sidewall surface facing the third surface and separate from the third surface, and a second sidewall surface facing the fourth surface and separate from the fourth surface,
the first sidewall surface includes a first section located at a side facing the first surface and a second section located at a side facing the support surface, the first section extending in a direction perpendicular to the support surface, the second section inclining so as to approach the third surface as extending from the side facing the first section toward the support surface,
the second sidewall surface includes a third section located at a side facing the first surface and a fourth section located at a side facing the support surface, the third section extending in the direction perpendicular to the support surface, the fourth section inclining so as to approach the fourth surface as extending from the side facing the third section toward the support surface, and
the first, the second, the third, and the fourth sections reflect at least part of the light.

4. The light source apparatus according to claim 1, wherein
the base member has a recess configured to support the holding member.

5. The light source apparatus according to claim 1, wherein
thermal conductivity of the holding member is higher than thermal conductivity of the base member.

6. The light source apparatus according to claim 1, wherein
the holding member is supported by the base member via a thermally conductive member.

7. The light source apparatus according to claim 1, wherein
the base member has a front surface to which the substrate is fixed, a rear surface facing a side opposite from the front surface, and a through hole passing the front surface and the rear surface, and
the holding member is supported by the through hole in the base member.

8. The light source apparatus according to claim 7,
further comprising a heat dissipation member disposed at a side facing the rear surface of the base member,
wherein the heat dissipation member is thermally coupled to the holding member supported by the through hole and exposed to a space facing the rear surface.

9. The light source apparatus according to claim 7, wherein
the base member further has a cutout provided in the front surface and communicating with the through hole, and
the holding member has a protrusion fixed into the cutout.

10. The light source apparatus according to claim 1, wherein
the light emitter emits first light having a first wavelength band, and
the light guide member is a wavelength conversion member that contains a phosphor, and is configured to convert the first light emitted from the light emitter into second light having a second wavelength band different from the first wavelength band and output the second light.

11. A projector comprising:
the light source apparatus according to claim 1;
a light modulator configured to modulate light output from the light source apparatus; and
a projection optical apparatus configured to project the light modulated by the light modulator.
